(19) United States
(12) Patent Application Publication
(10) Pub. No.: US 2017/0272784 A1
(43) Pub. Date: Sep. 21, 2017

(54) LIVE VIDEO BROADCASTING METHOD AND DEVICE

(71) Applicant: Xiaomi Inc., Beijing (CN)

(72) Inventors: Jin Shang, Beijing (CN); Zhigang Li, Beijing (CN); Youzhi Zhang, Beijing (CN)

(73) Assignee: Xiaomi Inc., Beijing (CN)

(21) Appl. No.: 15/334,076

(22) Filed: Oct. 25, 2016

(30) Foreign Application Priority Data
Mar. 16, 2016 (CN) 201610150798.7

(51) Int. Cl. H04N 21/2187; G06F 3/16; H04N 21/6332; H04N 21/422; H04N 21/233; H04N 21/234

(52) U.S. Cl. CPC H04N 21/2187; H04N 21/233; H04N 21/234; H04N 21/6332; H04N 21/42203; G06F 3/165

(57) ABSTRACT

Methods and devices are disclosed for performing and controlling, in a hand-free manner, interactive live video broadcasting from a mobile terminal. The mobile terminal may synthesize video information from image information taken by a separate image acquisition element installed on, e.g., smart glasses and audio information taken by a separate audio acquisition element. The audience of the video broadcast may send interactive messages to the mobile terminal. The message may be relayed to and displayed by a wearable device such as a wristband worn by the user of the mobile terminal. The messages may be further converted to voice messages and relayed to and played in a headset. The broadcasting of video information and voice rendering of interactive messages from the audience may be controlled either by voice command from the user of the mobile terminal or control keys on the wearable device. The voice commands from the user and contained in the audio information may be extracted for control and further removed from the audio information before being synthesized with the image information into the video information.

### CROSS-REFERENCE TO RELATED APPLICATIONS

This application is based upon and claims priority to Chinese Patent Application No. 201610150798.7, filed on Mar. 16, 2016, the entire contents of which are incorporated herein by reference.

### TECHNICAL FIELD

The present disclosure generally relates to communications technology, and more particularly, to a live video broadcasting method and device.

### BACKGROUND

With the advancement of the information technology, We Media has emerged. Everyone may become an information disseminator, and may send information to information recipients in various dissemination forms, including: written dissemination, image dissemination, audio dissemination, video dissemination or the like. Compared with the other dissemination forms, video dissemination may be capable of distributing information more vividly and provide social media experience that is more immersive.

People may utilize personal computers, mobile terminals or the like for live video broadcasting. In particular, users of mobile terminals may utilize the mobile terminals for live video broadcasting when being located outdoors and on the move, taking advantage of the mobility and portability of the mobile terminals. It is thus helpful to improve user experience in such condition for live video broadcasting.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a live video broadcasting method, applied to a mobile terminal is disclosed. The method includes receiving image information sent by smart glasses, the image information being acquired by an image acquisition element installed on the smart glasses; synthesizing video information from the image information and audio information separate from the image information and acquired by an audio acquisition element; and sending the video information to a video playing terminal.

In another embodiment, a live video broadcasting device is disclosed. The device includes: a processor; and a memory configured to store instructions executable by the processor, wherein the processor is configured to: receive image information sent by smart glasses, the image information being acquired by an image acquisition element arranged on the smart glasses; synthesize video information from the image information and audio information separate from the image information and acquired by an audio acquisition element; and send the video information to a video playing terminal.

In yet another embodiment, a non-transitory computer-readable storage medium having stored therein instructions is disclosed. The instructions, when executed by a processor of a mobile terminal, causes the mobile terminal to receive image information sent by smart glasses, the image information being acquired by an image acquisition element arranged on the smart glasses; synthesize video information from the image information and audio information separate from the image information and acquired by an audio acquisition element; and send the video information to a video playing terminal

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 is a schematic diagram illustrating a system applicable to a live video broadcasting method, according to an exemplary embodiment.

FIG. 2 is a flow chart showing a method using a mobile terminal, smart glasses, and a video playing terminal for live video broadcasting according to an exemplary embodiment.

FIG. 3 is a flow chart showing audio information processing for controlling the live video broadcasting using voice command from a user, according to an exemplary embodiment.

FIG. 4 is flow chart showing information processing in synthesizing video information from image information and audio information for live video broadcasting.

FIG. 5 is a flow chart showing interactive messaging between a mobile terminal and a video playing terminal, according to an exemplary embodiment.

FIG. 6 is a flow chart showing control of the broadcasting using wearable equipment, according to an exemplary embodiment.

FIG. 7 is a flow chart showing establishment and customization of a correspondence relationship between user operations over a control key of the wearable equipment and a preset control instruction, according to an exemplary embodiment.

FIG. 8 is a flow chart showing voice interaction among a mobile terminal, a video playing terminal, and a headset, according to an exemplary embodiment.

FIG. 9 is a flow chart showing control of voice interaction using the wearable equipment, according to an exemplary embodiment.

FIG. 10 is another flow chart showing control of voice interaction using voice command from the user, according to an exemplary embodiment.

FIG. 11 is a block diagram illustrating a live video broadcasting device, according to an exemplary embodiment.

FIG. 12 is another block diagram illustrating a live video broadcasting device, according to an exemplary embodiment.

FIG. 13 is another block diagram illustrating a live video broadcasting device, according to an exemplary embodiment.

FIG. 14 is another block diagram illustrating a live video broadcasting device, according to an exemplary embodiment.

FIG. 15 is another block diagram illustrating a live video broadcasting device, according to an exemplary embodiment.

FIG. 16 is another block diagram illustrating a live video broadcasting device, according to an exemplary embodiment.

FIG. 17 is another block diagram illustrating a live video broadcasting device, according to an exemplary embodiment.

FIG. 18 is another block diagram illustrating a live video broadcasting device, according to an exemplary embodiment.

FIG. 19 is another block diagram illustrating a live video broadcasting device, according to an exemplary embodiment.

FIG. 20 is another block diagram illustrating a live video broadcasting device, according to an exemplary embodiment.

FIG. 21 yet another block diagram illustrating a live video broadcasting device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with some aspects related to the present disclosure as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

A user may own various interacting smart devices, such as a mobile terminal, a pair of smart glasses, wearable devices such as smart watch and wristband, and a headset. These smart devices may be in communication with one another and form an ecosystem for creating, viewing, hearing, and sharing multimedia information. For example, a user may broadcast live video from the mobile terminal and receive interactive messages from audience of the broadcasting. With the help of various smart devices, the user may achieve the broadcasting of live video in a hand-free manner and from a viewpoint that closely match what the user sees through his eyes. In addition, the user may view or hear the interactive messages from the audience without having to hold the mobile terminal. Specifically in this disclosure, rather than using camera and microphone of the mobile terminal itself to acquire the broadcasting video, the mobile terminal may instead synthesize the broadcasting video information from image information taken by a separate image acquisition element installed on, e.g., the smart glasses, and audio information taken by a separate audio acquisition element. The term “image” refers to visual content of the live broadcasting taken by the camera. Likewise, the interactive message sent from the audience of the live broadcasting may be relayed from the mobile terminal to, and displayed in the wearable device worn by the user of the mobile terminal, rather than displayed in the mobile terminal itself. The interactive messages may be further converted to voice messages and may be relayed to and played in a headset. The broadcasting of video information and voice rendering of interactive messages from the audience may be controlled either by voice command from the user of the mobile terminal or control keys on the wearable device. The voice commands uttered by the user and contained in the audio information may be identified and extracted for control purposes and may be further removed from the audio information before being synthesized with the image information into the broadcast video information.

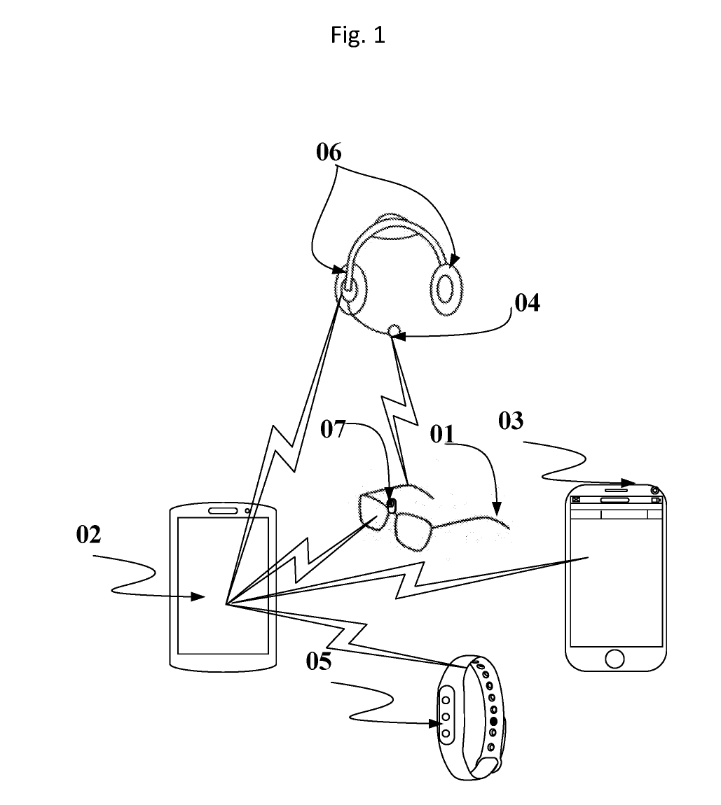

FIG. 1 is a schematic diagram illustrating a system for live video broadcasting, according to an exemplary embodiment. The system includes: smart glasses 01, a mobile terminal 02, and a video playing terminal 03, wherein an image acquisition element 07 is preferably arranged or installed on the smart glasses. Alternatively, the image acquisition element may be installed in the mobile terminal 01. The image acquisition element 07 may be, for example, a camera. The smart glasses 01 may also be in communication with an audio acquisition element 04. The audio acquisition element may be physically separate from or installed on the smart glasses. The audio acquisition element 04 may alternatively be an element arranged or installed on the mobile terminal 02. The audio acquisition element 04 may be, for example, a Microphone (MIC). Further, the image acquisition element 07 may alternatively to an element arranged or installed on the mobile terminal 02.

The mobile terminal 02 may be in communication with the smart glasses 01, and may also be in communication with the video playing terminal 03. Communication between the smart glasses 01 and the mobile terminal 02 and between the smart glasses 01 and the audio acquisition element 03 may be implemented in Bluetooth (BT). The mobile terminal 02 and the video playing terminal 03 may be connected through a wireless local area network, and may alternatively be connected to each other by individually connecting to the Internet through their own mobile communication interfaces.

Optionally, as shown in FIG. 1, the system may further include wearable equipment 05, wherein the wearable equipment 05 may have a display function. For example, a display screen may be installed on the wearable equipment. A preset number of control keys may also be arranged on the wearable equipment 05. Communication between the wearable equipment 05 and the mobile terminal 02 may be implemented via BT. The wearable equipment 05 may, for example, be a wrist device such as a smart watch or a smart band.

As shown in FIG. 1, the system may further include a headset 06. The headset 06 may be in communication with the mobile terminal 02. The connection between the headset 06 and the mobile terminal 02 may be based on BT. The audio acquisition element 04 discussed above may also be installed in the headset 06. For example, the audio acquisition element 04 may be a MIC installed in the headset. Alternatively, the audio acquisition element may be a built-in component in the mobile terminal. Unless specified, the term audio acquisition element or MIC may refer to any one of these audio acquisition elements. The headset 06 may output audio to the user and may also be replaced with other types of audio output device, e.g., a speaker.

A user may wear the smart glasses and the wearable equipment. In the embodiments disclosed below, the broadcasting live video content may be generated by the audio and image acquisition elements in communication with the smart glasses. The contents may be communicated to the mobile terminal for further broadcasting. The user need not hold the mobile terminal in his/her hands. The user may not even need to have the mobile terminal with him/her as long as the communication between the smart glasses and mobile terminal is established. Further, the user may control the broadcasting of live video by the mobile terminal using voice or control keys on the wearable equipment.

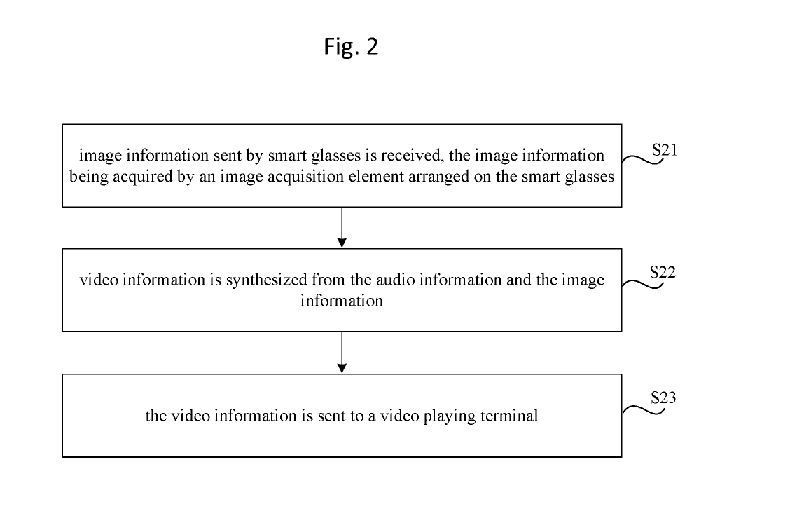

Referring to FIG. 2, FIG. 2 is a flow chart showing a live video broadcasting method, according to an exemplary embodiment. As shown in FIG. 2, the live video broadcasting method may be implemented in the mobile terminal 02 of FIG. 1.

At Step S21, image information sent by the smart glasses is received. The image information may be, for example, acquired by the image acquisition element installed on the smart glasses.

At Step S22, video information is synthesized based on the audio information and the image information.

At Step S23, the video information is sent to a video playing terminal.

In the present disclosure, the user may carry the mobile terminal, or place the mobile terminal within a range capable of keeping an uninterrupted communication with the smart glasses, via, for example, Bluetooth (or BT). The image information, for example, may comprise video images taken by the image acquisition element. Audio information may be recorded by the audio acquisition element. Synthesizing the image and audio information into the video information may involve synchronously combining the recorded voice with the images as they are being recorded

Since the image acquisition element is preferably arranged or installed on the smart glasses, if the user of the mobile terminal wears the smart glasses (the user being either in motion or stationary at a particular site), the image acquisition element may acquire image information within a field of vision of the user of the mobile terminal. The image acquisition element may then send the acquired image information to the smart glasses. The smart glasses may in turn send the received image information to the mobile terminal. Because the image acquisition element is near the eyes of the user, the acquired image information likely represents what the user of the mobile terminal observes from his/her perspective.

The mobile terminal then receives the image information sent by the smart glasses. The mobile terminal further synthesizes the audio information and the received image information into the video information. The mobile terminal then sends the synthesized video information containing both the image information and audio information to the video playing terminal. The video playing terminal then plays the received video information to a user of the video playing terminal, also referred to as the audience of the live broadcasting.

By means of the above implementation, the user of the mobile terminal, either in movement or stationary at a specific site, may conveniently and speedily provide live video broadcasting to the video playing terminal for sharing the video information of scenes observed by the user of the mobile terminal from where the user is located.

In the implementation above, there may be multiple alternative sources for the audio information in Step S22. Therefore, before Step S22 is executed, the mobile terminal may further execute the following steps with respect to the audio information. For example, the audio information may be acquired by the audio acquisition element in communication with the smart glasses. Audio information may accordingly be sent by the smart glasses to the mobile terminal. Alternatively, if the mobile terminal is with the user, the audio information may be obtained by the audio acquisition element installed on the mobile terminal and is thus acquired by the mobile terminal directly.

Specifically, the audio information may be acquired by the audio acquisition element in communication with the smart glasses. The audio acquisition element sends the acquired audio information to the smart glasses after acquiring the audio information in the environment where the user of the mobile terminal is located. The smart glasses then sends the received audio information to the mobile terminal. Alternatively, the audio information may also be acquired by a built-in audio acquisition element of the mobile terminal and the mobile terminal thus acquire the audio information directly (when the mobile terminal is with the user). In another implementation, an audio acquisition element may be installed in the mobile terminal in addition to the separate audio acquisition element 04. The user may determine or select which audio acquisition element is used to acquire the audio information. The selection may be made by the user via a setup interface provided in the mobile terminal or may be made using voice command as described below. The user may switch between the built-in audio acquisition element in the mobile terminal and the separate audio acquisition element 04 while the audio information is being acquired.

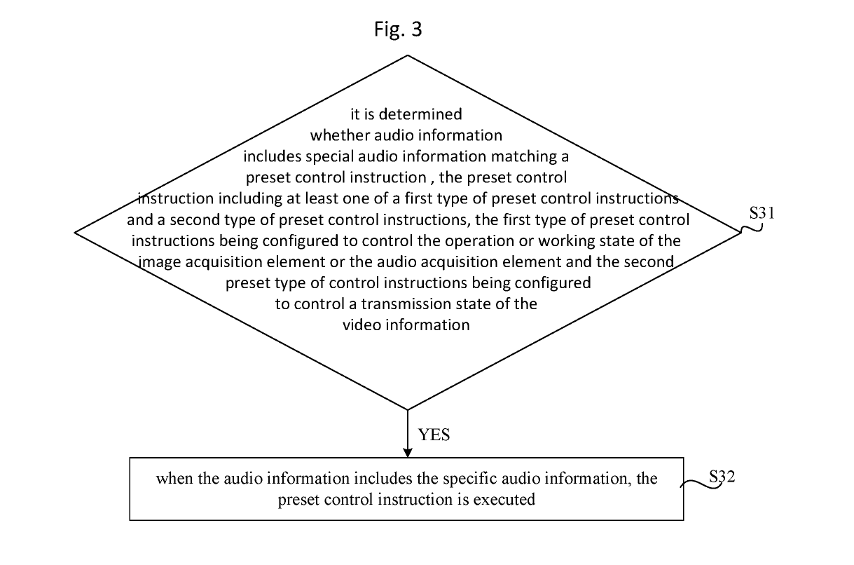

In the present disclosure, the audio information acquired by the audio acquisition element (either the separate audio acquisition element or the built-in audio acquisition element in the mobile terminal, as described above) in the environment where the user of the mobile terminal is located may include voice information input to the audio acquisition element by the user. For example, the audio acquisition element may acquire voice commands uttered by the user of the mobile terminal for controlling the equipment included in the system shown in FIG. 1. In addition, the user may utter voice commands for controlling the transmission state of the video information. The audio information acquired by the audio acquisition element may thus further include voice command for controlling the transmission state of the video information. Therefore, as shown in FIG. 3, the mobile terminal may further execute the following steps.

At Step S31, it is determined by the mobile terminal whether the audio information includes special audio information matching a preset control instruction, the preset control instruction including at least one of a first type of preset control instructions and a second type of preset control instructions. The first type of preset control instructions may be configured to control the operation or working state of the image acquisition element or the audio acquisition element. The second type of preset control instructions may be configured to control transmission state of the video information.

At Step S32, when the audio information includes the special audio information, the preset control instruction associated with the special audio information is executed.

The working state of the image acquisition element in Step S31 and S32 may include the on-off states of the image acquisition element, and may also include a value of an adjustable/controllable parameter of the image acquisition element, such as exposure, shutter speed and aperture size. When the image acquisition element includes a front camera and a rear camera (of the mobile terminal), the working state of the image acquisition element may further include working state for both the front and rear cameras. For example, the working state of the image acquisition element may include on-off status of both the front camera and the rear camera.

The working state of the audio acquisition element in Step S31 and Step S32 may include the on-off status of the audio acquisition element. The working state of the audio acquisition element may also include value of an adjustable/controllable parameter of the audio acquisition element, such as sensitivity (or recording volume), noise suppression capability and the like.

Transmission state of the video information that may be controlled by control commands may include: a transmission progression, transmission speed, whether the transmission is in progress or disabled, whether the transmission is paused, whether the transmission skips to next video segment or reverts to previous video segment, or whether the transmission is in fast forwarded or backward mode.

When the user of the mobile terminal inputs or utters voice information into the audio acquisition element in communication with the smart glasses, the audio acquisition element in communication with the smart glasses may acquire the voice information and send the voice information to the smart glasses which further sends the voice information to the mobile terminal. Then, the mobile terminal may process the audio information and determines whether the voice information includes special voice information matching a preset control instruction or not. The mobile terminal may then execute any matching control instruction.

For example, the user may desire to turn on the image acquisition element in the smart glasses and begin video broadcasting. The user may conveniently utter into the audio acquisition element “turn on the camera in my glasses”. For another example, the user may desire to switch from the camera in the smart glasses to the built-in camera in the mobile terminal while live video is being broadcasted. In such situation, the user of the mobile terminal may inputs voice information “I want to switch to the rear camera of the mobile terminal” to the audio acquisition element. In either case, the audio acquisition element may send the voice information to the mobile terminal directly, or to the smart glasses which further send the detected voice information to the mobile terminal. The mobile terminal then determines that the voice information includes a special command for turning on the camera in the smart glasses or switching from the camera in the smart glasses to the rear camera of the mobile terminal. The mobile terminal may then proceed to execute the command and turn on the camera in the smart glasses or switch from the camera in the smart glasses to the rear camera of the mobile terminal (by turning off the camera in the smart glasses and turning on the rear camera in the terminal). The images acquired by the appropriate camera may then be used for live video broadcasting.

By means of the implementation above, the user of the mobile terminal may input voice information, including commands to control the functioning of the equipment included in the system shown in FIG. 1. The user may further input voice information including commands to control the transmission state of the video information. The control is convenient and can be speedy. No matter whether the user is on the move or stationary at a specific site, the user of the mobile terminal may input voice commands to exert hand-free control over the equipment or control over the transmission state of the video information. User experience is thus improved.

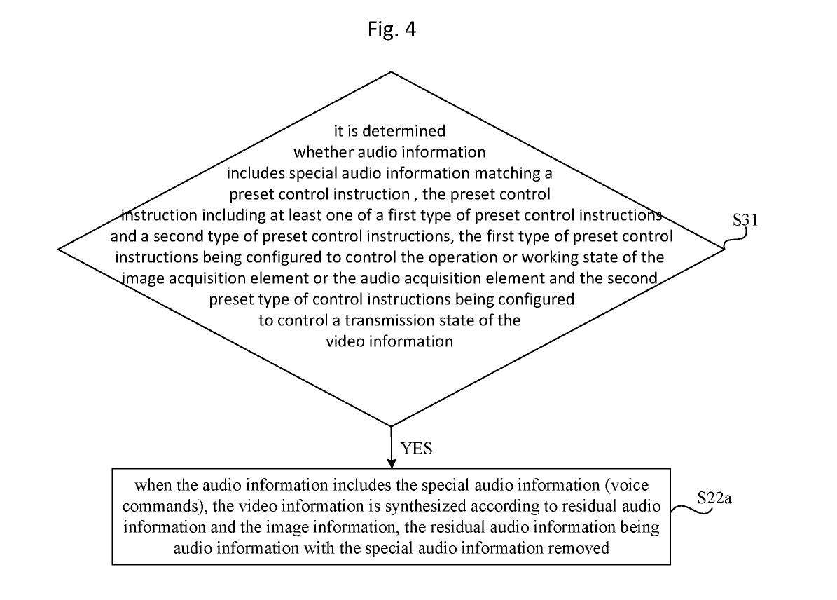

Since the audio acquisition element may acquire all audio signal in the environment where the user of the mobile terminal is located, the audio information acquired by the audio acquisition element may include audio information from the surroundings of the user of the mobile terminal and audio information uttered by the user of the mobile terminal. The voice information uttered by the user may include both voice information that the user intends to share with the audience, i.e., the user of the video playing terminal, and voice commands that are only intended for controlling the various equipment of FIG. 1 or controlling the transmission of the video information. It may thus be desired to separate voice commands from the rest of the audio information (the surrounding audio information and the voice information uttered by the user and intended for sharing). The voice commands may be considered voice information not intended for sharing with the audience. Including voice commands in the audio information to be shared may lead to unwanted interference with the experience of the user of the video playing terminal. Thus, it may be desired that the voice commands uttered by the user but not intended for the audience be removed from the audio information that is to be shared and to be synthesized into the video information and sent to the video playing terminal. Removing voice commands further offers the advantage of reduced power consumption of the mobile terminal and the video playing terminal, and savings in resources required for transmitting the voice commands. Therefore, as shown in FIG. 4, after the mobile terminal finishes executing Step S31, it may execute Step S22a.

At Step S22a, when the audio information includes the special audio information, the video information is synthesized according to residual audio information and the image information, the residual audio information being audio information with the special audio information (or voice commands uttered by the user) removed.

After the audio acquisition element acquires and sends the audio information of the environment where the user of the mobile terminal is located to the smart glasses, the smart glasses further send the environmental audio information to the mobile terminal. Upon receiving the audio information, the mobile terminal determines whether the received audio information includes voice information configured to control the equipment of the system shown in FIG. 1 or voice information configured to control the transmission state of the video information. If the mobile terminal determines that such voice command information is included in the audio information, then the mobile terminal removes such command information from the audio information when synthesizing the video information. In determining whether the audio information contains special voice commands, any speech and voice recognition technique may be employed.

For example, the user of the mobile terminal may utter voice information “I want to turn on the cell phone rear camera” to the audio acquisition element. As such, the audio information acquired by the audio acquisition element includes the audio information of the surrounding of the user, and further includes the voice information input to the audio acquisition element by the user of the mobile terminal. The audio acquisition element sends the acquired audio information to the mobile terminal directly or through the smart glasses. Use speech recognition technologies, the mobile terminal determines whether the received audio information includes special audio information matching a preset control instruction. The mobile terminal in this case determines that the received audio information includes voice information “turn on the cell phone rear camera” matches a preset control instruction (such as “start the rear camera”). The mobile terminal may remove the voice command information input by the user from the audio information when synthesizing the video information. The video information sent to the video playing terminal thus does not include voice information “I want to turn on the cell phone rear camera,” and the audience, i.e., the user of the video playing terminal, may not hear the voice information “I want to turn on the cell phone rear camera,” when watching the video. The user of the video playing terminal thus experience no undesired interference.

By means of the implementation above, the user-input voice command information configured to control the equipment of the system shown in FIG. 1 or voice command information configured to control the transmission state of the video information is not synthesized into the video sent to the video playing terminal, so that the user of the video playing terminal may not hear the corresponding voice command information. Interference with the experience of the user of the video playing terminal is reduced. The power consumption of the mobile terminal and the power consumption of the video playing terminal are further reduced. The resources required to transmit the video information are also reduced. User experiences may be improved.

The removal of the voice command information is optional. In some situation, the user may prefer to include the voice command information in the synthesized video information to be transmitted to the video playing terminal. In such cases, the voice command information may be kept. The user of the mobile terminal may set such preference via an user setup interface on the mobile terminal.

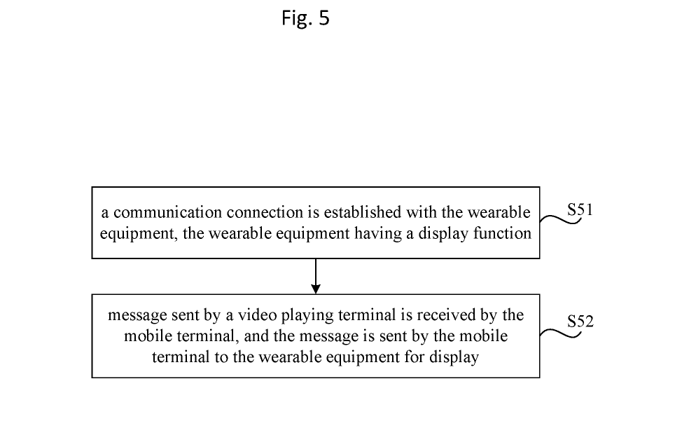

In one further embodiment according to the present disclosure, interactive communication between the user of the mobile terminal and the user of the video playing terminal involving the wearable equipment may be implemented as shown in FIG. 5.

At Step S51, a communication connection is established between the mobile terminal with the wearable equipment having a display function.

At Step S52, a message sent by the video playing terminal is received by the mobile terminal, and the message is sent by the mobile terminal to the wearable equipment for the wearable equipment to display the message. The message may be, for example, a text.

Specifically, after the mobile terminal establishes a communication connection with the video playing terminal, message may be transmitted between the mobile terminal and the video playing terminal. The video playing terminal may send the message to the mobile terminal after the communication connection is established regardless of whether the mobile terminal has sent any video information to the video playing terminal yet. In other words, the video playing terminal may send the message to the mobile terminal after or before the mobile terminal sends any video information to the video playing terminal.

For example, the user of the video playing terminal may send the message to the mobile terminal on initiative of the video playing terminal. Such message sent to the mobile terminal by the video playing terminal may be related to the video information sent to the video playing terminal by the mobile terminal, such as a feedback of the user of the video playing terminal about the video information sent to the video playing terminal by the mobile terminal. The feedback information may be a message such as “your move is so cool!” The message sent to the mobile terminal by the video playing terminal may alternatively be unrelated to the video information sent to the video playing terminal by the mobile terminal. Such message may be, for example, a chatting message between the user of the video playing terminal and the user of the mobile terminal, e.g., “what's your mobile phone model?”

The user of the mobile terminal may further wear the wearable equipment that may be used for displaying the message from the video playing terminal above. A communication connection may be established between the mobile terminal and the wearable equipment. The mobile terminal may send the received message from the video playing terminal (either related or unrelated to the video information sent from the mobile terminal to the video playing terminal) to the wearable equipment. The wearable equipment may further display the message after receiving it. As such, the user of the mobile terminal may conveniently check and view messages sent from the video playing terminal on his/her wearable equipment rather than on the mobile terminal.

For example, the wearable equipment worn by the user of the mobile terminal may be a wrist device such as a smart watch or a wristband. The user of the video playing terminal may send text information to the mobile terminal, the text information may be further sent from the mobile terminal to the smart watch or wristband. The smartwatch or wristband may then display the text information. In such a manner, the user of the mobile terminal may conveniently check and view the information sent by the user of the video playing terminal by lifting his/her wrist only and without having to reach for the mobile terminal.

By means of the implementation above, no matter whether the user of the mobile terminal is in motion or stationary at a specific site, the user of the mobile terminal may conveniently and speedily view and check messages sent from the user of the video playing terminal on the wearable equipment. For example, the wearable equipment may be a wrist device, such as a smart watch or a wristband. The user of the mobile terminal may check messages sent by the user of the video playing terminal by lifting his/her wrist rather than operating the mobile terminal. Thus, the user of the mobile terminal may check and view messages from the video playing terminal in a hand-free manner. The user may thus be freed to do other things in parallel. User experience is thus improved.

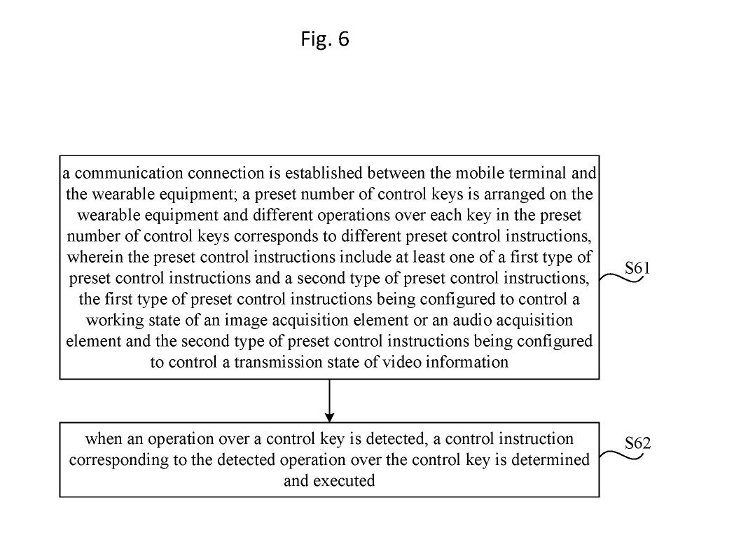

In another embodiment according the present disclosure, the equipment of the system shown in FIG. 1 or the transmission state of the video information may be controlled not only according to the voice command information uttered by the user of the mobile terminal, but also through the preset number of control keys arranged on the wearable equipment. Thus, when the communication connection is established between the mobile terminal and the wearable equipment, the equipment of the system shown in FIG. 1 or the transmission state of the video information may also be controlled from the wearable equipment. As such, the mobile terminal may, as shown in FIG. 6, further execute the following steps.

At Step S61, a communication connection is established between the mobile terminal and the wearable equipment. A preset number of control keys are arranged on the wearable equipment. The keys may be operated to generate a set of predefined control instructions. Each control key may be operated in various different manners. Each operation manner may correspond to a predefined control instruction of the set of control instructions. The predefined control instructions may include at least one of the first type of preset control instructions and the second type of preset control instructions. The first type of preset control instructions may be configured to control the operation or working state of the image acquisition element or the audio acquisition element and the second type of preset control instructions may be configured to control the transmission state of the video information.

At Step S62, when an operation over a control key in the preset number of control keys is detected, a control instruction corresponding to the detected operation is determined and executed.

Since the wearable equipment is worn by the user and thus held by the user via parts of the body of the user other than hands, the wearable equipment may be easier to operate compared with the mobile terminal. For example, a wrist device may be worn by the user and affixed to the wrist of the user of the mobile terminal, the user may conveniently operate the wearable equipment. The mobile terminal may establish the communication connection with the wearable equipment. The control over the various equipment of the system shown in FIG. 1 or control over the transmission state of the video information may be implemented using the preset number of control keys of the wearable equipment via the mobile terminal. The preset number of control keys may be physical keys, and may alternatively be virtual keys, such as touch keys on a touch screen.

Each control key in the preset number of control keys of the wearable equipment may correspond to a preset control instruction, and each control key may correspond to multiple preset control instructions. When each control key corresponds to multiple preset control instructions, different operations over the control key corresponds to different preset control instructions.

For example, a control key (e.g., labeled as key number 1) may correspond to two preset control instructions: turning on the image acquisition element and turning off the image acquisition element. A single-click operation over the key number 1 may correspond to the preset control instruction of turning on the image acquisition element whereas a double-click operation over the key number 1 may correspond to the preset control instruction of turning off the image acquisition element.

When an operation over a control key in the preset number of control keys is detected, a control instruction corresponding to the detected operation over the control key is executed.

Continuing with the example above, when double-click operation over the key number 1 is detected, the preset control instruction of turning off the image acquisition element is executed. As a result of the execution of the instruction, the image acquisition element may be turned off.

By means of the implementation above, the user of the mobile terminal may carry out operation on the wearable equipment to implement convenient and speedy control over various equipment of the system shown in FIG. 1 or control over the transmission state of the video information. No matter whether the user of the mobile terminal is on the move or is stationary at a specific site, he/she may perform operation on the wearable equipment to carry out control over various equipment of FIG. 1 rather an via the mobile terminal. As such, the user may not need to hold the mobile terminal at all times but still conveniently exert control over the equipment of FIG. 1. The user may thus free up his/her hands for other tasks. User experience may thus be improved.

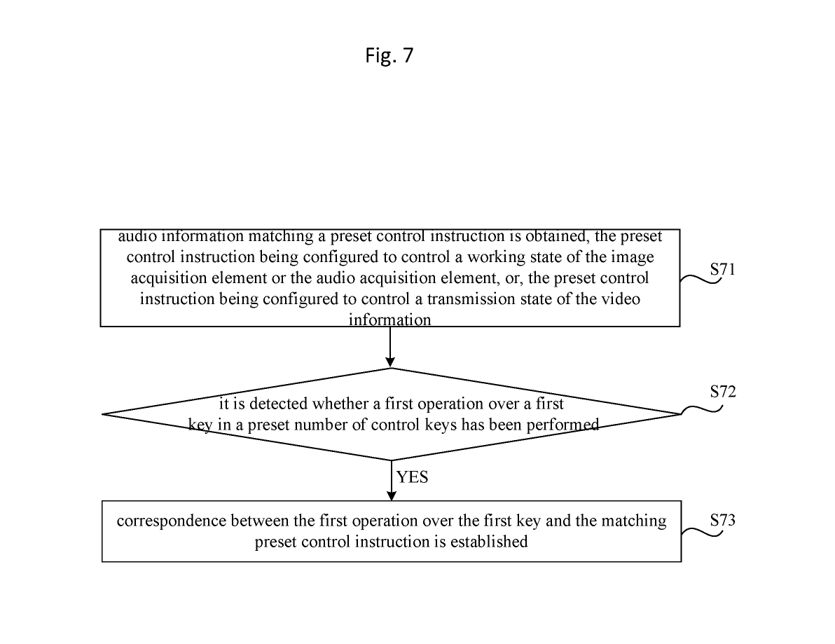

In a further embodiment involving the wearable equipment having control keys, the user of the mobile terminal may set a customized correspondence relationship between various different operations over the control keys and different preset control instructions. As such, the mobile terminal may, as shown in FIG. 7, further execute the following steps.

At Step S71, audio information matching a preset control instruction is obtained by the mobile terminal, wherein the preset control instruction is configured to control the working state of the image acquisition element or the audio acquisition element, or configured to control the transmission state of the video information.

At Step S72, it is detected by the wearable equipment whether a first operation over a first key among the preset number of control keys has been performed by the user.

At Step S73, when the first operation over the first key is detected and the control instruction contained in the audio information is extracted, a correspondence relationship between the detected first operation and the control instruction in the audio information is established and stored. The correspondence relationship may be stored in the mobile terminal or in the wearable equipment.

Steps S71 and Step S72 may be implemented in any order. The mobile terminal may execute Step S71 at first and then execute Step S72, and the mobile terminal may also execute Step S72 at first and then execute Step S71. Alternatively, Step S71 and Step S72 may be performed at the same time.

As described above and for Step S71, the audio information acquired by the audio acquisition element may include voice information input by the user of the mobile terminal. The voice information input by the user may be configured to control the equipment of the system shown in FIG. 1 or configured to control the transmission state of the video information. Therefore, the user may input voice commands configured to control the equipment of the system shown in FIG. 1 or voice commands configured to control the transmission state of the video information into the audio acquisition element and send the voice information containing the voice commands to the smart glasses. The smart glasses may further send the voice information or commands to the mobile terminal. In such a manner, the mobile terminal obtains the audio information acquired by the audio acquisition element via the smart glasses, and the audio information acquired by the audio acquisition element may include voice commands that match preset control instructions.

For example, when the audio acquisition element is a MIC, the user of the mobile terminal inputs voice information “I want to turn on the cell phone rear camera” to the MIC (or the audio acquisition element). The voice information acquired by the MIC includes the voice information input to the MIC by the user of the mobile terminal, and is sent to the smart glasses worn by the user of the mobile terminal. The smart glasses further send the voice information to the mobile terminal. As such, the voice information received by the mobile terminal includes voice information “turn on the cell phone rear camera” that matches the preset control instruction for turning on the camera of the mobile terminal.

Specifically for Step S72 and for the preset number of keys on the wearable equipment, the mobile terminal determines via the wearable equipment whether a particular key on the wearable equipment is operated by the user, and further, the specific operation performed by the user over the particular key.

After finishing executing Step S71 and Step S72, the mobile terminal executes Step S73. Specifically, after detecting the first operation over the first key and obtaining the voice command information matching the preset control instruction, the mobile terminal may establish a correspondence relationship between the matched preset control instruction and the first operation over the first key. In such a manner, if the user performs the same first operation over the same first key next time, the mobile terminal may executes the preset control instruction as the instruction corresponding to the key operation. Likewise, for each operation of each control key in the preset number of control keys of the wrist device, the user may customize correspondence relationships between different operations over different keys and different preset control instructions.

By means of the implementation above, the user of the mobile terminal may independently customize the correspondence relationships between different operations over different keys and different preset control instructions, so that the user may implement control over the equipment of the system shown in FIG. 1 or control over the transmission state of the video information by performing different customized operations on different keys on the wearable equipment. User experience is thus improved.

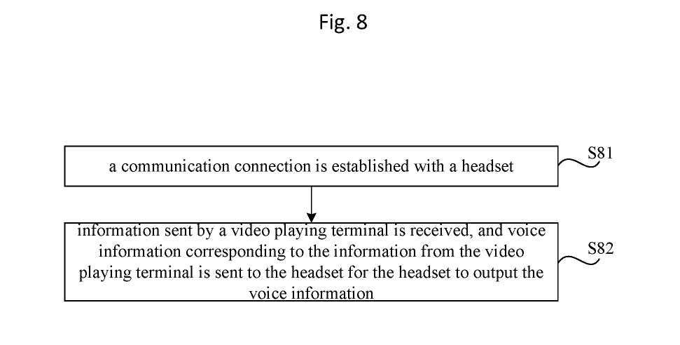

In another implementation, in order to achieve interactive communication between the user of the mobile terminal and the user of the video playing terminal, the mobile terminal may further interact with the headset of FIG. 1, as shown in FIG. 8. The mobile terminal thus may further execute the following steps.

At Step S81, a communication connection is established between the mobile terminal and the headset.

At Step S82, a message sent by the video playing terminal is received by the mobile terminal, and voice information may be extracted from the message sent from the video playing terminal and sent to the headset for output.

Specifically, after the mobile terminal establishes communication connection with the video playing terminal, the information may be transmitted between the mobile terminal and the video playing terminal. The video playing terminal may send message to the mobile terminal after the communication connection is established regardless of whether the mobile terminal has sent any video information to the video playing terminal yet. In other words, the video playing terminal may send the message to the mobile terminal after or before the mobile terminal sends any video information to the video playing terminal.

The addition of the headset worn by the user of the mobile terminal thus provides convenient means for the user of the mobile terminal to hear the message sent to the mobile terminal by the video playing terminal. The message may include audio information. The message may include other information (such as text) that may be converted by the mobile terminal into voice based on, for example, speech recognition. The mobile terminal may establish communication connection with the headset. Upon the establishment of this communication connection, the mobile terminal may send the voice information contained in the message received from the video displaying terminal to the headset.

For example, the user of the video playing terminal may send messages to the mobile terminal, and then voice information corresponding to the text information contained in the message may be extracted and converted into speech by the mobile terminal and sent to the headset worn by the user of the mobile terminal. As such, the user of the mobile terminal may hear the message sent by the user of the video playing terminal in audio form.

By means of the implementation above, the user of the mobile terminal may conveniently and speedily hear the message sent by the user of the video playing terminal via the headset. No matter whether the user of the mobile terminal is on the move or is stationary at a specific site, he/she may conveniently learn about the message sent by the user of the video playing terminal without having to operate the mobile terminal and in a hand-free manner. The user of the mobile terminal thus may be free to do other things in parallel. User experience may thus be improved.

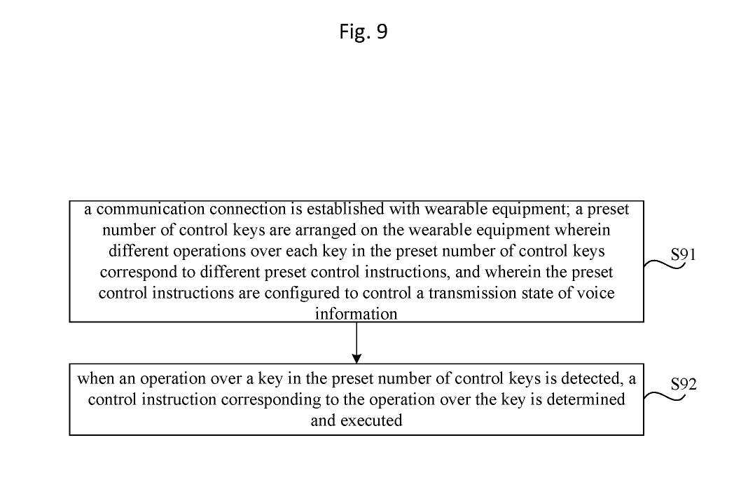

In another implementation, control over a transmission state of the voice information corresponding to the message sent by the video playing terminal may be implemented through the preset number of control keys of the wearable equipment. Therefore, the mobile terminal may, as shown in FIG. 9, further execute the following steps.

At Step S91, a communication connection is established between the mobile terminal and the wearable equipment. A preset number of control keys may be arranged on the wearable equipment. The keys may be operated to generate a set of predefined control instructions. Each control key may be operated in various different manners. Each operation manner may correspond to a predefined control instruction of the set of control instructions. The predefined control instructions are configured to control a transmission state of the voice information.

At Step S92, when an operation over a key in the preset number of control keys is detected, a control instruction corresponding to the operation over the key is determined and executed.

The term “transmission state of the voice information” in Step S91 is similar to the “transmission state of the video information” in Step S31. The transmission state of the voice information corresponding to the received information by the mobile terminal that may be controllable may include: a transmission progression of the voice information corresponding to the received information, or voice information transmission speed, whether the transmission is in progress or disabled , whether the transmission of the voice information corresponding to the received information is paused, whether the transmission of voice information skips to next voice segment or reverts to previous voice segment, whether the transmission is in fast forward or backward mode, a fidelity of the voice, or the like.

Manners in which Step S91 to Step S92 are implemented are similar to those for Step S61 to Step S62. The difference is that the preset control instructions corresponding to various operations over the keys of the wearable equipment have different functions.

For example, the user of the video playing terminal may send text information to the mobile terminal. The mobile terminal may convert the text information into voice and send the voice information corresponding to the text information to the headset worn by the user of the mobile terminal. The user of the mobile terminal may exert control over the voice information. For example, the user of the mobile terminal may exert control over a playing speed of the voice information. The user of the mobile terminal may achieve control of the voice information via various operations over different keys of the wearable equipment.

By means of the implementation above, the user of the mobile terminal may conveniently and speedily carry out operations on the wearable equipment to exert control over the transmission state of the voice information corresponding to the information sent to the mobile terminal by the video playing terminal. No matter whether the user of the mobile terminal is on the move or stationary at a specific site, he/she may carry out operations on the keys of the wearable equipment to exert control over the transmission state of the voice information corresponding to the information sent to the mobile terminal by the video playing terminal. User experience may thus be improved.

The correspondence relationship between the preset control instructions for controlling the transmission state of the voice information and the various operations over the control keys of the wearable equipment may be customized and established in a similar manner to the implementation shown in FIG. 7.

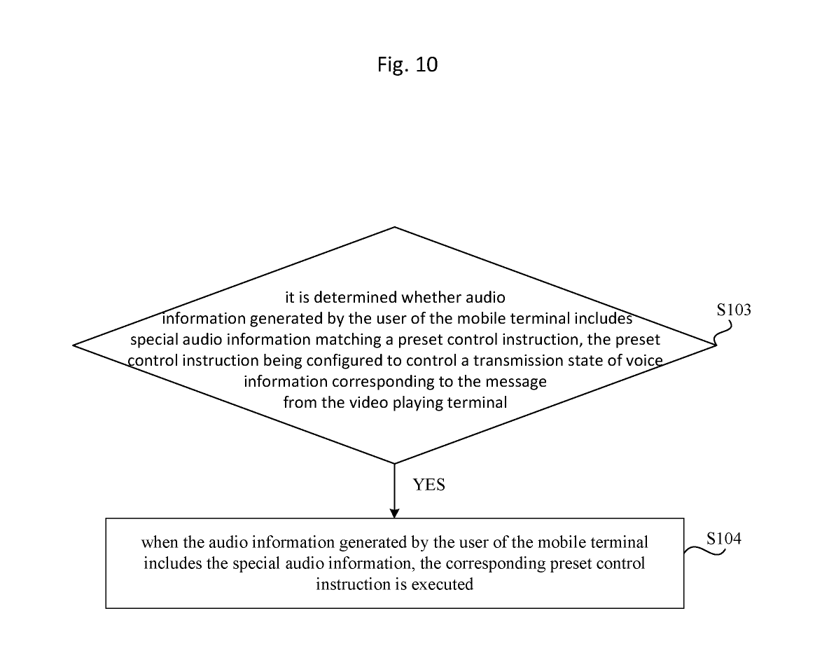

In another alternative embodiment according to FIG. 8, the transmission state of the voice information corresponding to the message sent to the mobile terminal by the video playing terminal may further be controlled according to the voice information input by the user of the mobile terminal. Therefore, In Step S82, after the mobile terminal receives the message sent by the video playing terminal, the mobile terminal may, as shown in FIG. 10, further execute the following steps.

At Step S103, it is determined whether the audio information generated by the user of the mobile terminal includes special audio information matching a preset control instruction, the preset control instruction being configured to control the transmission state of the voice information corresponding to the message from the video playing terminal.

At Step S104, when the audio information generated by the user of the mobile terminal includes the special audio information, the preset control instruction corresponding to the special audio information is executed.

Manners in which Step S103 to Step S104 are implemented are similar to those for Step S31 to Step S32, and the difference is that the preset control instructions have different functions.

For example, the user of the mobile terminal may input voice information “I want to listen to voice information corresponding to a next received message” into the audio acquisition element or MIC. The audio acquisition element or MIC sends the user generated voice information to the mobile terminal. The mobile terminal determines whether the voice information includes special audio information matching a preset control instruction. In this case, “play the voice information corresponding to the next received message” matches the preset control instruction for retrieving next message from the video playing terminal. The mobile terminal thus determines that an instruction for retrieving next message from the video playing device has been given by the user. The mobile terminal thus sends the voice information corresponding to the next received message from the video playing terminal to the headset. As such, the user of the mobile terminal may hear the voice information corresponding to the next received message via the headset.

By means of the implementation above, the user of the mobile terminal may input voice commands to further exert convenient and speedy control over the transmission state of the voice information corresponding to messages sent to the mobile terminal by the video playing terminal. No matter whether the user of the mobile terminal is on the move or stationary at a specific site, the user of the mobile terminal may input the voice commands to carry out hand-free control over the transmission state of the voice information corresponding to the messages sent to the mobile terminal by the video playing terminal. The user of the mobile terminal may thus be freed up to do other things in parallel. User experience is therefore improved.

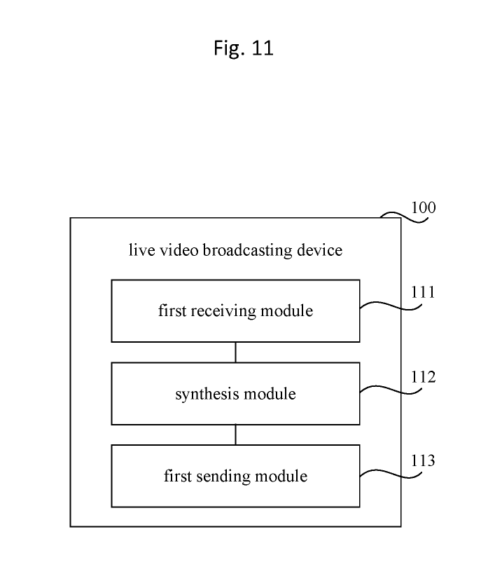

FIG. 11 is a block diagram of a live video broadcasting device, according to an exemplary embodiment. Referring to FIG. 11, the device 100 includes a first receiving module 111, a synthesis module 112 and a first sending module 113.

The first receiving module 111 is configured to receive image information sent by smart glasses, the image information being acquired by an image acquisition element arranged on the smart glasses. The synthesis module 112 is configured to synthesize video information according to audio information and the image information. The first sending module 113 is configured to send the video information to a video playing terminal.

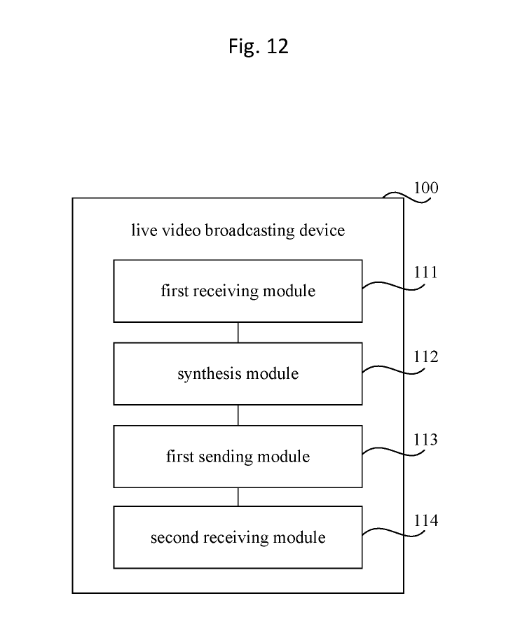

Optionally, the device 100 may further, besides the first receiving module 111, the synthesis module 112 and the first sending module 113, include: a second receiving module 114 and/or an acquisition module 115. For example, the device 100 may, as shown in FIG. 12, include: the first receiving module 111, the synthesis module 112, the first sending module 113 and the second receiving module 114.

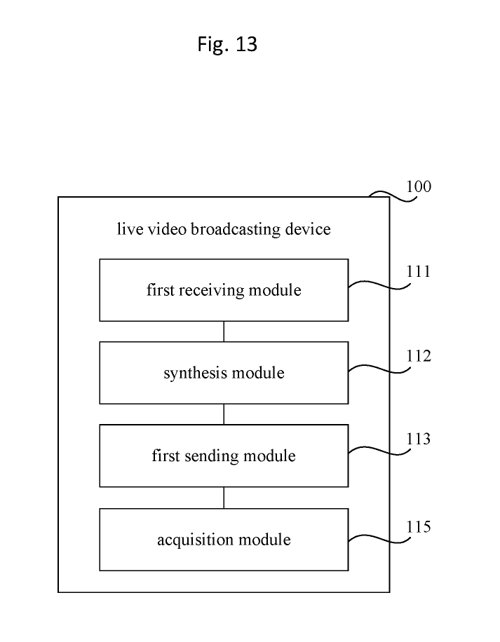

As another example, the device 100 may, as shown in FIG. 13, include: the first receiving module 111, the synthesis module 112, the first sending module 113 and the acquisition module 115.

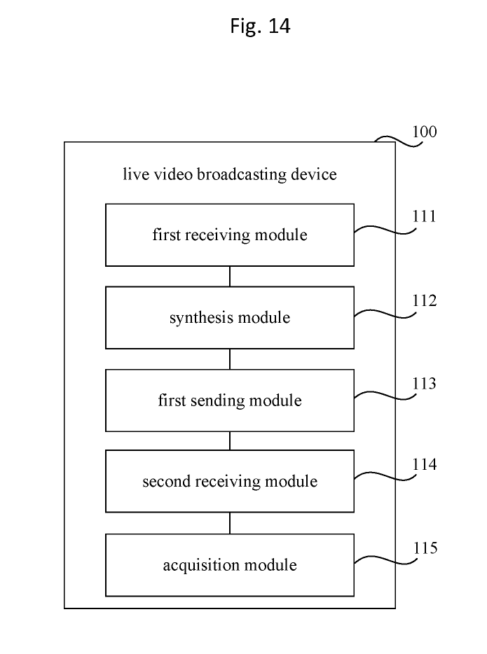

As a further example, the device may, as shown in FIG. 14, include: the first receiving module 111, the synthesis module 112, the first sending module 113, the second receiving module 114 and the acquisition module 115.

The second receiving module 114 is configured to receive the audio information sent by the smart glasses, the audio information being acquired by an audio acquisition element connected with the smart glasses.

The acquisition module 115 is configured to obtain the audio information acquired by a mobile terminal.

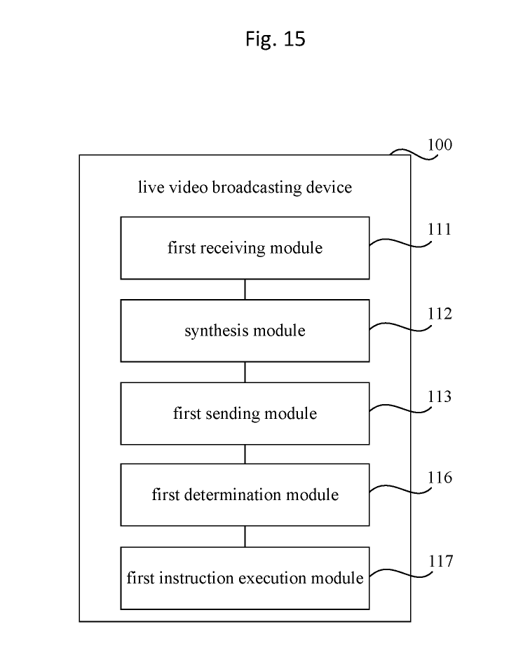

Optionally, as shown in FIG. 15, the device 100 may further, besides the first receiving module 111, the synthesis module 112 and the first sending module 113, include:

a first determination module 116, configured to determine whether the audio information includes special audio information matching a preset control instruction, the preset control instruction including at least one of a first type of preset control instructions and a second type of preset control instructions, the first type of preset control instructions being configured to control a working state of the image acquisition element or the audio acquisition element and the second type of preset control instruction being configured to control a transmission state of the video information; and

a first instruction execution module 117, configured to, when the audio information includes the special audio information, execute the preset control instruction.

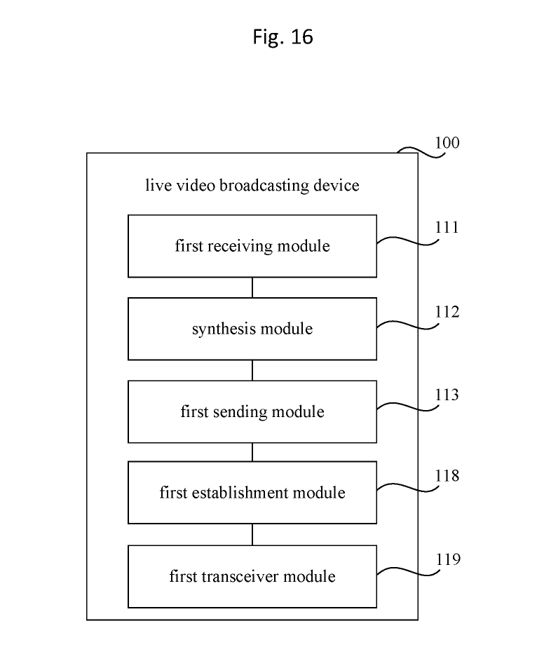

Optionally, as shown in FIG. 16, the device may further, besides the first receiving module 111, the synthesis module 112 and the first sending module 113, include:

a first establishment module 118, configured to establish a communication connection with wearable equipment, the wearable equipment having a display function; and

a first transceiver module 119, configured to receive information sent by the video playing terminal, and send the information to the wearable equipment for the wearable equipment to display the information.

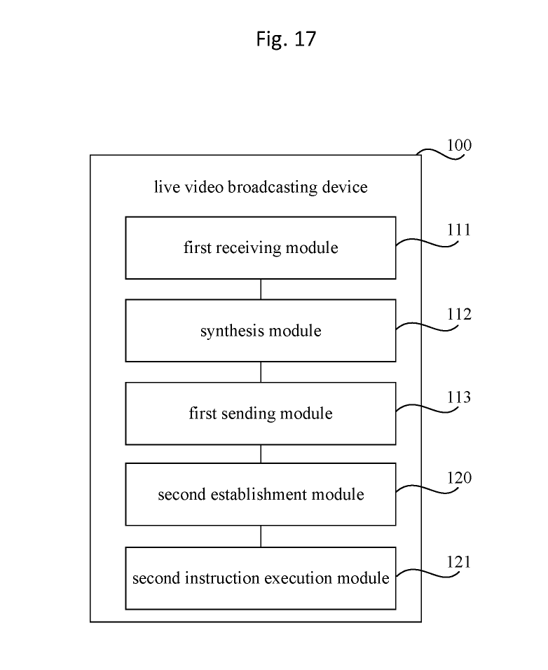

Optionally, as shown in FIG. 17, the device 100 may further, besides the first receiving module 111, the synthesis module 112 and the first sending module 113, include:

a second establishment module 120, configured to establish a communication connection with wearable equipment, wherein a preset number of control keys are arranged on the wearable equipment and different operations over each key in the preset number of control keys corresponding to different preset control instructions, and wherein the preset control instructions include at least one of the first type of preset control instructions and the second type of preset control instructions, the first type of preset control instructions being configured to control the working state of the image acquisition element or the audio acquisition element and the second type of preset control instructions being configured to control the transmission state of the video information; and

a second instruction execution module 121, configured to, when an operation over a key in the preset number of control keys is detected, execute a control instruction corresponding to the operation over the key.

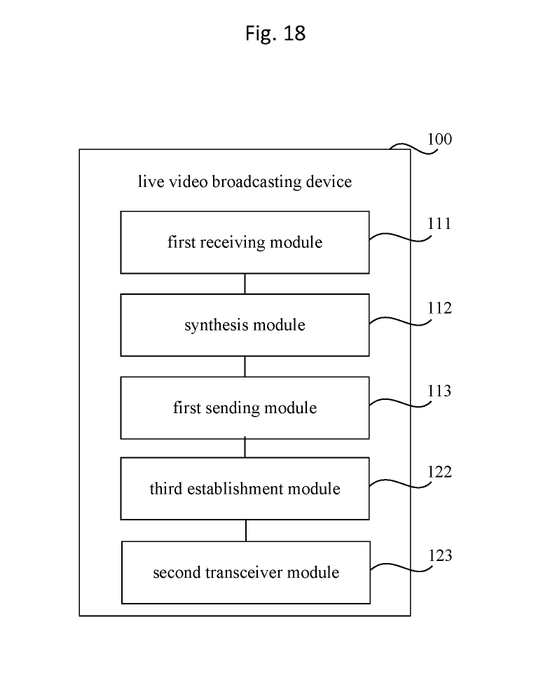

Optionally, as shown in FIG. 18, the device 100 may further, besides the first receiving module 111, the synthesis module 112 and the first sending module 113, include:

a third establishment module 122, configured to establish a communication connection with a headset; and

a second transceiver module 123, configured to receive the information sent by the video playing terminal, and send voice information corresponding to the information from the video playing terminal to the headset for the headset to output the voice information.

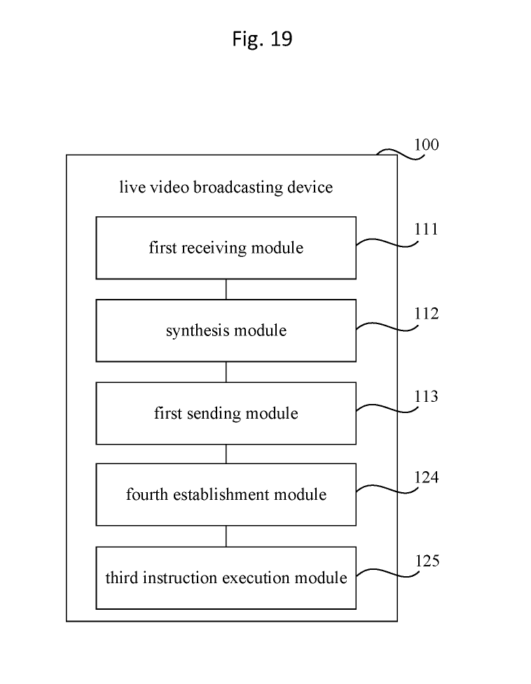

Optionally, as shown in FIG. 19, the device 100 may further, besides the first receiving module 111, the synthesis module 112 and the first sending module 113, include:

a fourth establishment module 124, configured to establish a communication connection with wearable equipment, wherein a preset number of control keys are arranged on the wearable equipment and different operations over each key of the preset number of control keys corresponds to different preset control instructions, and wherein the preset control instructions are configured to control a transmission state of the voice information from the video playing terminal; and

a third instruction execution module 125, configured to, when an operation over a key in the preset number of control keys is detected, execute a control instruction corresponding to the detected operation over the key.

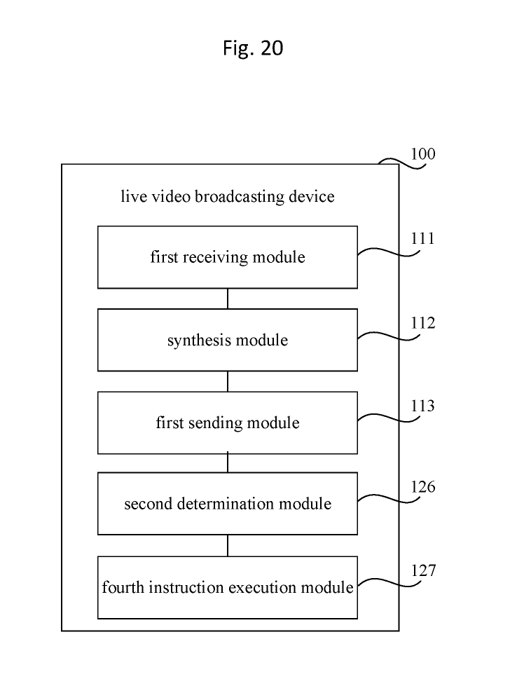

Optionally, as shown in FIG. 20, the device 100 may further, besides the first receiving module 111, the synthesis module 112 and the first sending module 113, include:

a second determination module 126, configured to, after a message sent by the video playing terminal is received, determine whether audio information input by the user of the mobile terminal includes special audio information matching a preset control instruction, the preset control instruction being configured to control the transmission state of the voice information contained in the message from the video playing terminal; and

a fourth instruction execution module 127, configured to, when the audio information contained in the message from the video playing terminal includes the special audio information, execute the preset control instruction corresponding to the special audio information.

With respect to the devices in the above embodiments, the specific manners for performing operations for individual modules therein have been described in detail in the corresponding method embodiments above. The description for the method embodiments applies to the corresponding device embodiments.

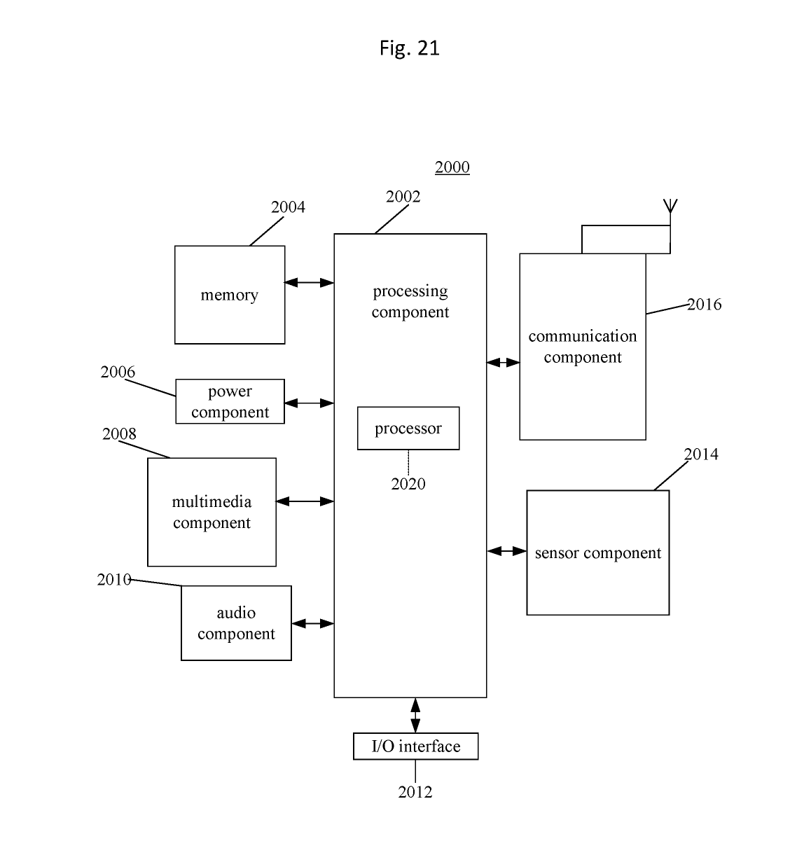

FIG. 21 is a block diagram illustrating a live video broadcasting device 2000, according to an exemplary embodiment. For example, the device 2000 may be a mobile phone, a computer, a digital broadcast terminal, a messaging device, a gaming console, a tablet, a medical device, exercise equipment, a Personal Digital Assistant (PDA) or the like.

Referring to FIG. 21, the device 2000 may include one or more of the following components: a processing component 2002, a memory 2004, a power component 2006, a multimedia component 2008, an audio component 2010, an Input/Output (/I/O) interface 2012, a sensor component 2014, and a communication component 2016.

The processing component 2002 typically controls overall operations of the device 2000, such as the operations associated with display, telephone calls, data communications, camera operations, and recording operations. The processing component 2002 may include one or more processors 2020 to execute instructions to perform all or part of the steps of the live video broadcasting method. Moreover, the processing component 2002 may include one or more modules which facilitate interaction between the processing component 2002 and the other components. For instance, the processing component 2002 may include a multimedia module to facilitate interaction between the multimedia component 2008 and the processing component 2002.

The memory 2004 is configured to store various types of data to support the operation of the device 2000. Examples of such data include instructions for any application programs or methods operated on the device 2000, contact data, phonebook data, messages, pictures, video, etc. The memory 2004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 2006 provides power for various components of the device 2000. The power component 2006 may include a power management system, one or more power supplies, and other components associated with the generation, management and distribution of power for the device 2000.

The multimedia component 2008 includes a screen providing an output interface between the device 2000 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 2008 includes a front camera and/or a rear camera. The front camera and/or the rear camera may receive external multimedia data when the device 2000 is in an operation mode, such as a photographing mode or a video mode. Each of the front camera and the rear camera may be a fixed optical lens system or have focusing and optical zooming capabilities.

The audio component 2010 is configured to output and/or input an audio signal. For example, the audio component 2010 includes a MIC, and the MIC is configured to receive an external audio signal when the device 2000 is in the operation mode, such as a call mode, a recording mode and a voice recognition mode. The received audio signal may be further stored in the memory 2004 or sent through the communication component 2016. In some embodiments, the audio component 2010 further includes a speaker configured to output the audio signal.

The I/O interface 2012 provides an interface between the processing component 2002 and a peripheral interface module, and the peripheral interface module may be a keyboard, a click wheel, a button or the like. The button may include, but not limited to: a home button, a volume button, a starting button and a locking button.

The sensor component 2014 includes one or more sensors configured to provide status assessment in various aspects for the device 2000. For instance, the sensor component 2014 may detect an on/off status of the device 2000 and relative positioning of components, such as a display and small keyboard of the device 2000. The sensor component 2014 may further detect a change in a position of the device 2000 or a component of the device 2000, presence or absence of contact between the user and the device 2000, orientation or acceleration/deceleration of the device 2000 and a change in temperature of the device 2000. The sensor component 2014 may include a proximity sensor configured to detect presence of an object nearby without any physical contact. The sensor component 2014 may also include a light sensor, such as a Complementary Metal Oxide Semiconductor (CMOS) or Charge Coupled Device (CCD) image sensor, configured for use in an imaging application. In some embodiments, the sensor component 2014 may also include an acceleration sensor, a gyroscope sensor, a magnetic sensor, a pressure sensor or a temperature sensor.

The communication component 2016 is configured to facilitate wired or wireless communication between the device 2000 and another device. The device 2000 may access a communication-standard-based wireless network, such as a Wireless Fidelity (WiFi) network, a 2nd-Generation (2G) cellular network, a 3rd-Generation (3G) cellular network, a LTE network, a 4th-Generation cellular network, or a combination thereof. In an exemplary embodiment, the communication component 2016 receives a broadcast signal or broadcast associated information from an external broadcast management system through a broadcast channel. In an exemplary embodiment, the communication component 2016 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In an exemplary embodiment, the device 2000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned live video broadcasting method.

In an exemplary embodiment, there is also provided a non-transitory computer-readable storage medium including instructions, such as the memory 2004 including instructions, and the instructions may be executed by the processor 2020 of the device 2000 to implement the abovementioned live video broadcasting method. For example, the non-transitory computer-readable storage medium may be a ROM, a Compact Disc Read-Only Memory (CD-ROM), a magnetic tape, a floppy disc, an optical data storage device or the like.

Each module, submodule, or unit discussed above for FIGS. 11-20, such as the first receiving module, the synthesis module, the first sending module, the second receiving module, the acquisition module, the first determination module, the first instruction execution module, the first establishment module, the first transceiver module, the second establishment module, the second instruction execution module, the third establishment module, the second transceiver module, the fourth establishment module, the third instruction execution module, the second determination module and the fourth instruction execution module may take the form of a packaged functional hardware unit designed for use with other components, a portion of a program code (e.g., software or firmware) executable by the processor 2020 or the processing circuitry that usually performs a particular function of related functions, or a self-contained hardware or software component that interfaces with a larger system, for example.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

We claim:

1. A live video broadcasting method, applied to a mobile terminal, the method comprising:
receiving image information sent by smart glasses, the image information being acquired by an image acquisition element installed on the smart glasses;
synthesizing video information from the image information and audio information separate from the image information and acquired by an audio acquisition element; and
sending the video information to a video playing terminal.

2. The method according to claim 1, further comprising, before synthesizing the video information from the image information and the audio information separate from the image information into the video information:
receiving the audio information from the smart glasses, the audio information being acquired by an audio acquisition element in communication with the smart glasses and separate from the image acquisition element.

3. The method according to claim 1, further comprising, before synthesizing the video information from the image information and audio information separate from the image information:
obtaining the audio information from an audio acquisition element installed in the mobile terminal.

4. The method according to claim 1, further comprising:
determining whether the audio information comprises special audio information matching a preset control instruction of a set of control instructions, the set of control instructions comprising at least one of a first type of preset control instructions and a second preset type of control instructions, wherein the first type of preset control instructions is configured to control a working state of the image acquisition element or the audio acquisition element and the second type of preset control instruction is configured to control a transmission state of the video information; and
executing the preset control instruction when it is determined that the audio information comprises the special audio information.

5. The method according to claim 1, further comprising:
establishing a communication connection with a wearable equipment, the wearable equipment having a display function; and
receiving a message sent by the video playing terminal, and sending the message to the wearable equipment for the wearable equipment to display the message.

6. The method according to claim 1, further comprising:
establishing a communication connection with a wearable equipment, wherein a preset number of control keys are arranged on the wearable equipment and different operations over each of the preset number of control keys correspond to different preset control instructions, wherein the preset control instructions comprise at least one of first type of preset control instructions and second type of preset control instructions, and wherein the first type of preset control instructions are configured to control a working state of the image acquisition element or the audio acquisition element and the second type of preset control instructions are configured to control a transmission state of the video information;
detecting an operation over a key of the preset number of control keys on the wearable equipment; and
when the operation is detected, executing a control instruction corresponding to the detected operation.

7. The method according to claim 1, further comprising:
establishing a communication connection with a headset; and
receiving a message sent by the video playing terminal, and sending voice information corresponding to the message to the headset for audio output.

8. The method according to claim 7, further comprising:
establishing a communication connection with wearable equipment, wherein a preset number of control keys are arranged on the wearable equipment and different operations over each key of the preset number of control keys correspond to different preset control instructions, wherein the preset control instructions are configured to control a transmission state of the voice information corresponding to the message sent by the video playing terminal;
detecting an operation over a key of the preset number of control keys on the wearable equipment; and
when the operation is detected, executing a control instruction corresponding to the detected operation.

9. The method according to claim 7, after receiving the message sent by the video playing terminal, the method further comprising:
determining whether the audio information separate from the image information comprises special audio information matching a preset control instruction of a set of control instructions, the set of control instructions being configured to control a transmission state of the voice information corresponding to the message sent by the video playing terminal; and
executing the preset control instruction when it is determined that the audio information comprises the special audio information.

10. A live video broadcasting device, configured in a mobile terminal, comprising:
a processor; and
a memory configured to store instructions executable by the processor,
wherein the processor is configured to:
receive image information sent by smart glasses, the image information being acquired by an image acquisition element arranged on the smart glasses;
synthesize video information from the image information and audio information separate from the image information and acquired by an audio acquisition element; and
send the video information to a video playing terminal.

11. The live video broadcasting device according to claim 10, wherein, when executing the instructions, the processor is further configured to, before synthesizing the video information from the image information and audio information separate from the image information,
receive the audio information sent by the smart glasses, the audio information being acquired by an audio acquisition element in communication with the smart glasses and separate from the image acquisition element.

12. The live video broadcasting device according to claim 10, wherein, when executing the instructions, the processor is further configured to, before synthesizing the video information from the image information and audio information separate from the image information,
obtain the audio information acquired by an audio acquisition element installed in the mobile terminal.

13. The live video broadcasting device according to claim 10, wherein the processor is further configured to:
determine whether the audio information comprises special audio information matching a preset control instruction of a set of control instructions, the set of control instructions comprising at least one of a first type of preset control instructions and a second type of preset control instructions, wherein the first type of preset control instructions are configured to control a working state of the image acquisition element or the audio acquisition element and the second type of preset control instruction is configured to control a transmission state of the video information; and
execute the preset control instruction when it is determined that the audio information comprises the special audio information.

14. The live video broadcasting device according to claim 10, wherein the processor is further configured to:
establish a communication connection with wearable equipment, the wearable equipment having a display function; and
receive message sent by the video playing terminal, and send the message to the wearable equipment for the wearable equipment to display the message.

15. The live video broadcasting device according to claim 10, wherein the processor is further configured to:
establish a communication connection with a wearable equipment, wherein a preset number of control keys are arranged on the wearable equipment and different operations over each of the preset number of control keys correspond to different preset control instructions, wherein the preset control instructions comprise at least one of first type of preset control instructions and second type of preset control instructions, and wherein the first type of preset control instructions are configured to control a working state of the image acquisition element or the audio acquisition element and the second type of preset control instructions are configured to control a transmission state of the video information;
detect an operation over a key of the preset number of control keys on the wearable equipment; and
when the operation is detected, execute a control instruction corresponding to the detected operation.

16. The live video broadcasting device according to claim 10, wherein the processor is further configured to:
establish a communication connection with a headset; and
receive a message sent by the video playing terminal, and send voice information corresponding to the message to the headset for audio output.

17. The live video broadcasting device according to claim 16, wherein the processor is further configured to:
establish a communication connection with wearable equipment, wherein a preset number of control keys are arranged on the wearable equipment and different operations over each key of the preset number of control keys correspond to different preset control instructions, wherein the preset control instructions are configured to control a transmission state of the voice information corresponding to the message sent by the video playing terminal;
detect an operation over a key of the preset number of control keys on the wearable equipment; and
when the operation is detected, execute a control instruction corresponding to the detected operation.

18. The live video broadcasting device according to claim 16, wherein the processor is further configured to, after receiving the message sent by the video playing terminal:
determine whether the audio information separate from the image information comprises special audio information matching a preset control instruction of a set of control instructions, the set of control instructions being configured to control a transmission state of the voice information corresponding to the message sent by the video playing terminal; and
execute the preset control instruction when it is determined that the audio information comprises the special audio information.

19. A non-transitory computer-readable storage medium having stored therein instructions that, when executed by a processor of a mobile terminal, causes the mobile terminal to:
receive image information sent by smart glasses, the image information being acquired by an image acquisition element arranged on the smart glasses;
synthesize video information from the image information and audio information separate from the image information and acquired by an audio acquisition element; and
send the video information to a video playing terminal.
